(19) United States
(12) Patent Application Publication
(10) Pub. No.: US 2013/0222947 A1
(43) Pub. Date: Aug. 29, 2013

(54) REMOVABLE COVER ASSEMBLY FOR A DATA STORAGE DEVICE

(71) Applicants: Taisuke Sugii, Ibaraki (JP); Masaru Muranishi, Kanagawa (JP); Nobuyuki Isoshima, Ibaraki (JP); Takehiko Eguchi, Tokyo (JP)

(72) Inventors: Taisuke Sugii, Ibaraki (JP); Masaru Muranishi, Kanagawa (JP); Nobuyuki Isoshima, Ibaraki (JP); Takehiko Eguchi, Tokyo (JP)

(21) Appl. No.: 13/409,011

(22) Filed: Feb. 29, 2012

(51) Int. Cl. G11B 33/02; G11B 5/48; G06F 1/16; G11B 19/20

(52) U.S. Cl. 360/99.08; 361/679.31; 361/679.37; G9B/19.028; G9B/5.153; G9B/33.003

(57) ABSTRACT

A removable cover assembly for a data storage device comprises a first cover coupled with a casing base of a data storage device via a plurality of screws. A second cover is disposed upon a rib of the casing base and is coupled with the rib. The second cover is configured with a groove which delineates a perimeter separating an interior region of the second cover from an exterior region of the second cover. A space between the first cover and the casing base is filled with a low-density gas. The groove defines the region in the second cover in which separation of the interior region from the exterior region is to occur to expose the screws.

### TECHNICAL FIELD

Embodiments relate generally to the field of hard-disk drives (HDDs), and in particular to disk enclosures for hard-disk drives.

### BACKGROUND

Magnetic disk drives are generally fabricated as a unit comprising one or more magnetic disks rotationally driven by a spindle motor. A magnetic head for the read/write of magnetic information on the magnetic disks is supported by a carriage arm, and the drive of a voice-coil motor (VCM) enables access to a desired track and read/write of the data thereof. Because of an ever-increasing demand for the improved read/write speed in recent years, the magnetic disks are rotated at higher speeds. This results in the structural vibration of the disk and/or the carriage arm or the like known as “flow-induced vibration” in which the air dragged by the rotation of the magnetic disks and pumped into the magnetic disk unit is generated as a high speed flow. This flow-induced vibration is a principal cause of positioning error of the magnetic head, and serves as an obstacle to the development of higher-density, higher-speed magnetic disk units. In addition, a shearing force is generated on the magnetic disks by air accompanying the rotation of the magnetic disks, and significant power is needed by the spindle motor to rotate the magnetic disks to overcome this resistance.

One method considered for resolving these problems involves sealing a low-density gas in the magnetic disk units. Typically, the drive is pumped with air, but if this air is replaced with a low-density gas, the excitation force attributable to air is suppressed, and the required power to rotate the magnetic disks is reduced. This is because the hydrodynamic force produced by the fluid is proportional to the density and the square of speed. In addition, the reason for the reduction in the required power is because, while a state of flow turbulence is produced when the drive is pumped with air, the use of a low-density gas results in a drop in the dimensionless number referred to as the Reynolds number. This results in a reduction in the flow turbulence and, in turn, in a reduction in the shearing force. While the use of hydrogen or helium as the low-density gas has been considered, in actual practice helium is typically used because of its high stability. However, helium molecules are small in size and, in typical casings employed in magnetic disk drives pumped with helium, gas leaks to the exterior of the unit occur through the screw portion or seal during the use of the disk drive. One solution to this problem has been to provide a first cover on the casing interior and to weld a second cover onto the casing base to provide an air-tight seal to the casing.

Additionally, the process of manufacturing magnetic disk drives includes an inspection to ensure that established specifications and performance standards are met. If defects are discovered in this inspection, the magnetic disk drives which are defective are disassembled, the problematic component(s) are replaced, or the problem-free components are re-used in a process known as reworking. However, if the second cover described above is welded to the casing base, the cutting or grinding of the welded seal results in the introduction of dust and cutting chips into the disk drive itself. These can be further distributed throughout the disk drive if it is subsequently put into operation resulting in the dust and cutting chips becoming deposited upon the magnetic disks, or into gaps between the magnetic disks and the slider. This can potentially cause floating instability of the slider, head crash, and magnetic disk damage. In other words, dust generated in this way removal or reworking of parts is rendered more difficult and the reliability of component parts following reworking is lowered.

Additionally, in recent years the issue of how to efficiently recover rare earths contained in various industrial products has arisen. For example, neodymium magnets which contain rare earths, such as neodymium, in the VCM are also employed in magnetic disk units. The method used for recovering the neodymium magnet from the interior of a used magnetic disk unit is dependent on the objective and the cost and will involve either breakage of the magnetic disk unit to remove the magnet, or opening the cover of the magnetic disk unit to remove the magnet. In magnetic disk units described above which have a welded second cover, opening the cover necessitates opening of the welded second cover.

### SUMMARY

A removable cover assembly for a data storage device comprises a first cover coupled with a casing base of a data storage device via a plurality of screws. A second cover is disposed upon a rib of the casing base and is coupled with the rib. The second cover is configured with a groove which delineates a perimeter separating an interior region of the second cover from an exterior region of the second cover. A space between the first cover and the casing base is filled with a low-density gas. The groove defines the region in the second cover in which separation of the interior region from the exterior region is to occur to expose the screws.

### DESCRIPTION OF THE DRAWINGS

The accompanying drawings, which are incorporated in and form a part of this specification, illustrate various embodiments and, together with the description, serve to explain the embodiments. The drawings referred to in this description should not be understood as being drawn to scale except if specifically noted.

FIG. 1 is a plan view of an example hard-disk drive in accordance with one or more embodiments.

FIG. 2 is an exploded perspective view of a hard-disk drive in accordance with one or more embodiments

FIG. 3 is a cross-section view of an example hard disk drive in accordance with one or more embodiments.

FIG. 4 is a cross-section view of a portion of a hard-disk drive in accordance with one or more embodiments.

FIG. 5 is a perspective view of an example hard-disk drive in accordance with one or more embodiments.

FIG. 6 is a cross-section view of an example hard disk drive in accordance with one or more embodiments.

FIG. 7 is a perspective view of an example hard-disk drive in accordance with one embodiment.

FIG. 8 is a cross-section view of a portion of a hard-disk drive in accordance with one or more embodiments.

FIG. 9 is a perspective view of an example hard-disk drive in accordance with one or more embodiments.

FIG. 10 is a perspective view of an example hard-disk drive in accordance with one or more embodiments.

FIG. 11 is a perspective view of an example hard-disk drive in accordance with one or more embodiments.

FIGS. 12A, 12B, 12C, and 12D show example cross-sectional shapes of grooves in a second cover of a hard disk drive used in accordance with one or more embodiments.

FIG. 13 shows an example arrangement of grooves in a second cover of a hard disk drive in accordance with one or more embodiments.

FIG. 14 is a perspective view of an example hard-disk drive in accordance with one or more embodiments.

FIG. 15 is a cross-section view of a portion of a hard-disk drive in accordance with one or more embodiments.

FIG. 16 is a perspective view of an example hard-disk drive in accordance with one or more embodiments.

FIG. 17 is a cross-section view of a portion of a hard-disk drive in accordance with one or more embodiments.

### DESCRIPTION OF EMBODIMENTS

Reference will now be made in detail to various alternative embodiments. While the numerous alternative embodiments will be described, it will be understood that they are not intended to be limiting. On the contrary, the described embodiments are intended to cover alternatives, modifications and equivalents, which may be included within the spirit and scope as defined by the appended claims.

Furthermore, in the following description of embodiments, numerous specific details are set forth in order to provide a thorough understanding. However, it should be appreciated that various embodiments may be practiced without these specific details. In other instances, well known methods, procedures, and components have not been described in detail as not to unnecessarily obscure embodiments. Throughout the drawings, like components are denoted by like reference numerals, and repetitive descriptions are omitted for clarity of explanation if not necessary.

### Physical Description of Embodiments of a Removable Cover Assembly for a Data Storage Device

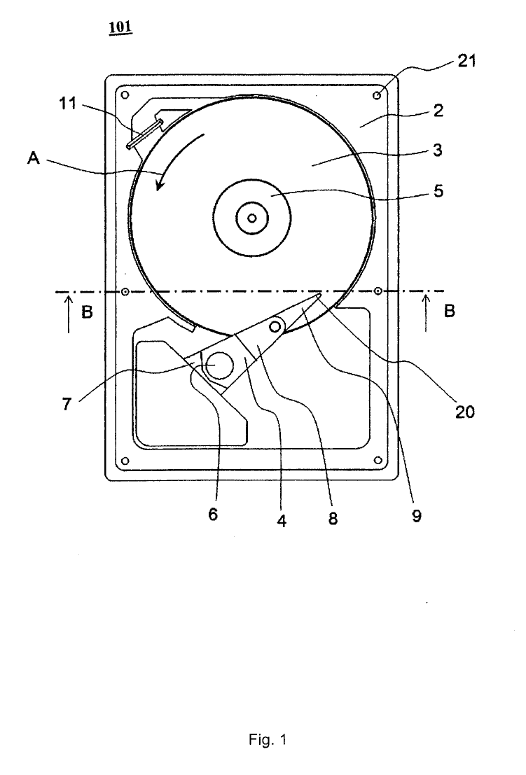

FIG. 1 shows an example hard-disk drive (HDD) 101 in accordance with one or more embodiments. In FIG. 1, a cover (not shown) of hard-disk drive 101 has been removed to view interior components of hard-disk drive 101. In FIG. 1, one or more magnetic disks 3 which are rotatably coupled with a spindle and are rotationally driven by a spindle motor 5 at revolutions of, for example, 7200 RPM in an anti-clockwise direction in by arrow A. A carriage 4 is affixed with freedom to rotate within a pre-determined angle range about a pivot axis 6 in a casing base 2. The carriage 4 constitutes a structure in which an actuator arm 8 is rotated within a pre-determined angle as a result of a drive force from a voice-coil motor (VCM) 7. In one example, an armature of VCM 7, including a voice coil attached to the carriage 4; and a stator including a voice-coil magnet (not shown). The armature of the VCM is attached to the carriage 4 and is configured to move the actuator arm 8 and magnetic head 20 to access portions of the magnetic disks 3, as the carriage 4 is mounted on pivot axis 6 with an interposed pivot-bearing assembly. The proximal end of a load beam 9 is connected to the distal end of actuator arm 8 for positioning a magnetic head 20 for performing data read/write of the data stored on magnetic disks 3. The spinning of magnetic disks 3 by spindle motor 5 creates an airflow including an air-stream, and a self-acting air bearing on which the air-bearing surface (ABS) of a head-slider to which magnetic head 20 is coupled rides the air-stream so that the head-slider flies in proximity with the recording surface of the magnetic disks 3 to avoid contact with a thin magnetic-recording medium of the magnetic disks 3 in which information is recorded. As a result of the rotation of the actuator arm 8 in a pre-determined angle range by the drive of VCM 7, the magnetic head 20 is able to be moved to the desired track for the reading/writing of data to magnetic disks 3. Furthermore, a filter 11 is provided to collect dust from the air-stream within hard-disk drive 101 created by the spinning of magnetic disks 3.

Information is typically stored on the magnetic disks 3 in a plurality of concentric tracks (not shown) arranged in sectors on the magnetic disks 3. Correspondingly, each track is composed of a plurality of sectored track portions. Each sectored track portion is typically composed of recorded data and a header containing a servo-burst-signal pattern, for example, an ABCD-servo-burst-signal pattern, information that identifies the track, and error correction code information. In accessing the track, the read element of the magnetic head 20 reads the servo-burst-signal pattern which provides a position-error-signal (PES) to the servo electronics, which controls the electrical signal provided to the voice coil of VCM 7, enabling the magnetic head 20 to follow the desired track. Upon finding the desired track and identifying a particular sectored track portion, the magnetic head 20 either reads data from the track, or writes data to, the track depending on instructions received by a disk controller from an external agent, for example, a microprocessor of a computer system.

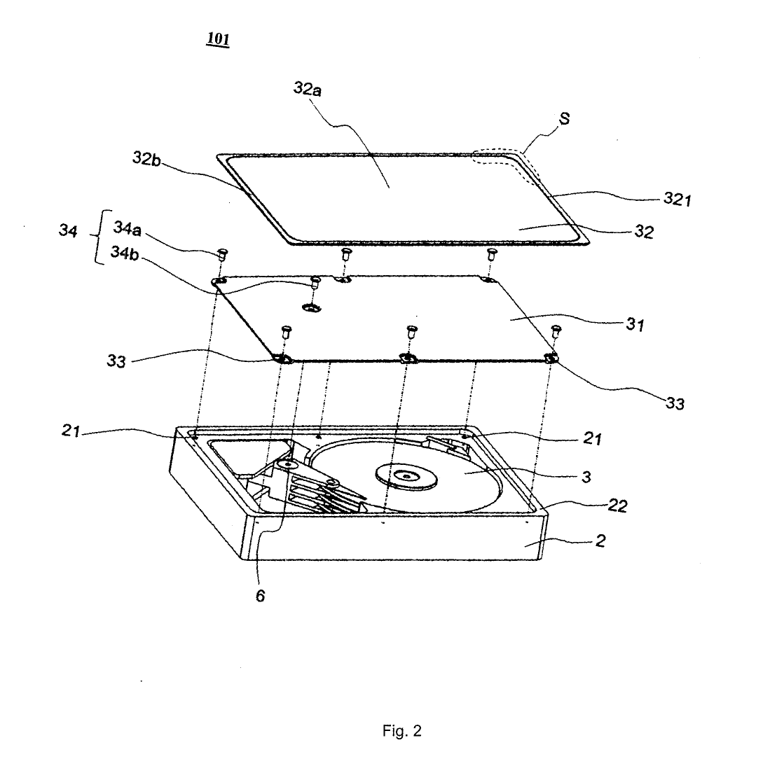

As described above with reference to FIG. 1 various embodiments encompass within their scope a hard-disk drive 101 that includes a magnetic disk 3, a disk enclosure including a casing base 2, a spindle motor 5 affixed in casing base 2, for rotating the magnetic disk 3, an actuator arm 8, and a magnetic head 20 attached to the actuator arm 8. Furthermore, a first cover (e.g., 31 of FIG. 2) coupled with a casing base 2 of hard-disk drive 101 via a plurality of screws. A second cover (e.g., 32 of FIG. 2) is disposed upon a rib of the casing base 2 and is coupled with the rib. The second cover 32 is configured with a groove (e.g., 321 of FIG. 2) which delineates a perimeter separating an interior region (e.g., 32a of FIG. 2) of the second cover 32 from an exterior region (e.g., 32b of FIG. 2) of the second cover. A space between the first cover 31 and the casing base 2 is filled with a low-density gas. The groove 321 defines the region in the second cover in which separation of the interior region from the exterior region is to occur to expose the screws. It is noted that while the descriptions of various embodiments are provided in the context of a hard-disk drive, various embodiments can be implemented on other types of data storage devices as well.

FIG. 2 is a perspective view of a hard-disk drive (HDD) 101 in accordance with one or more embodiments. In FIG. 2, casing base 2 comprises a rib 22 and screw holes 21 in the outer edge portion of casing base 2. A first cover 31 is coupled with casing base 2 on the interior side of rib 22 using, for example, screws 34, through holes 33, and screw holes 21. In the embodiment shown in FIG. 2, screws 34 comprise base screws 34a for fastening first cover 31 with casing base 2, and a pivot screw 34b for fastening first cover 31 with pivot 6. In one embodiment, pivot 6 is disposed at one end of pivot shaft described with reference to FIG. 1. Also shown in FIG. 2 is a second cover 32 which is coupled with rib 22 to cover the upper side of first cover 31.

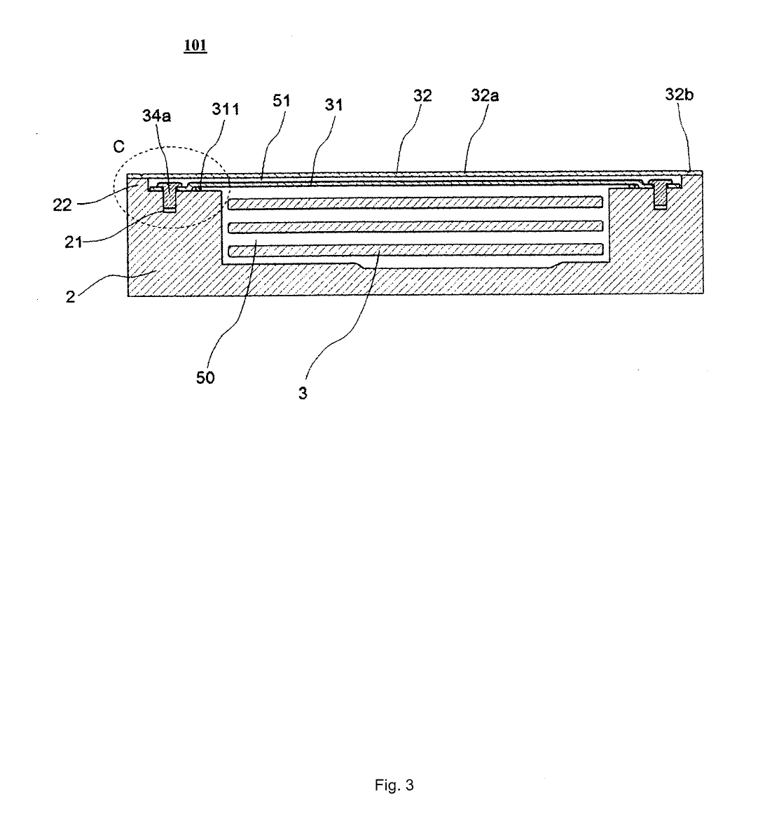

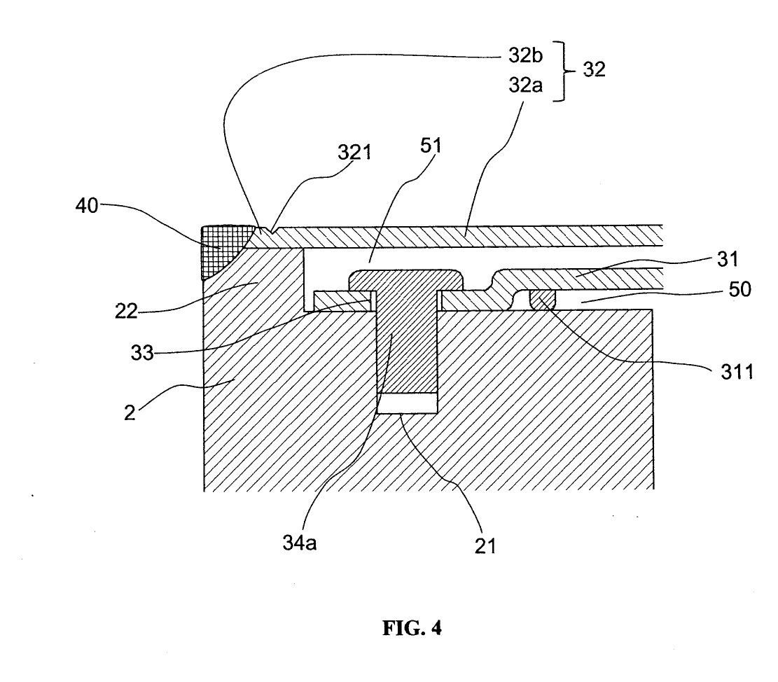

FIG. 3 is a cross-section view along the line B-B of FIG. 1 while region C of FIG. 3 is shown in greater detail in the partial expanded view shown in FIG. 4. With reference now to FIGS. 3 and 4, in one embodiment a gasket 311 is disposed along the circumference where first cover 31 comes into contact with casing base 2. In accordance with one or more embodiments, gasket 311 is formed from an elastic material such as rubber and deforms as a result of first cover 31 being pushed toward casing base 2 by the fastening of screws 34 which therefore acts as a seal between the housing space 50 within hard-disk drive 101 where magnetic-recording disk is located and a space 51 formed between first cover 31 and second cover 32. As a result, even when gases and dust are generated when second cover 32 is welded, the infiltration of dust and gases into the housing space 50 is prevented by first cover 31. Second cover 32 is disposed on top of rib 22 and the welded portion 40 is formed, for example, by laser welding and is joined to rib 22.

In accordance with one or more embodiments, second cover 32 comprises a groove 321 interior to the welded portion 40 and which essentially parallels the circumference of second cover 32. In the example of FIG. 4, groove 321 is disposed to the outside, or farther to the outer edge of hard-disk drive 101, relative to the outside edge of first cover 31. Furthermore, groove 321 delineates a perimeter separating an interior region 32a and an exterior region 32b of second cover 32.

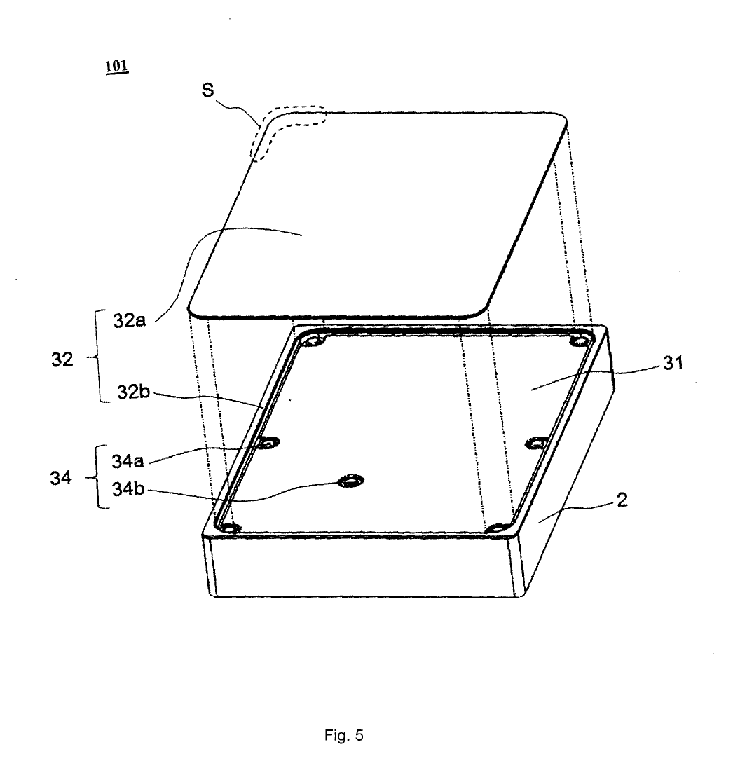

As described above, opening of first cover 31 may be performed during reworking of hard-disk drives, as well as during the recovery of rare earths contained in components of hard-disk drives. In accordance with one or more embodiments, when opening second cover 32, a cutting tool is initially employed to form a cutting line in groove 321 for partial opening. The cutting tool may comprise a sharp cutting edge that is thinner than the thickness of groove 321. In one example, a partial region of groove 321, such as region S shown by the broken line in FIG. 2, is sufficient. Thereafter, the interior region 32a of second cover 32 is lifted up from the partially opened region S, and second cover 32 is opened (e.g., peeled) by shearing and breaking along groove 321. This is shown in FIG. 5 which is a perspective view of an opened hard-disk drive 101 in which interior region 32a has been separated as described above.

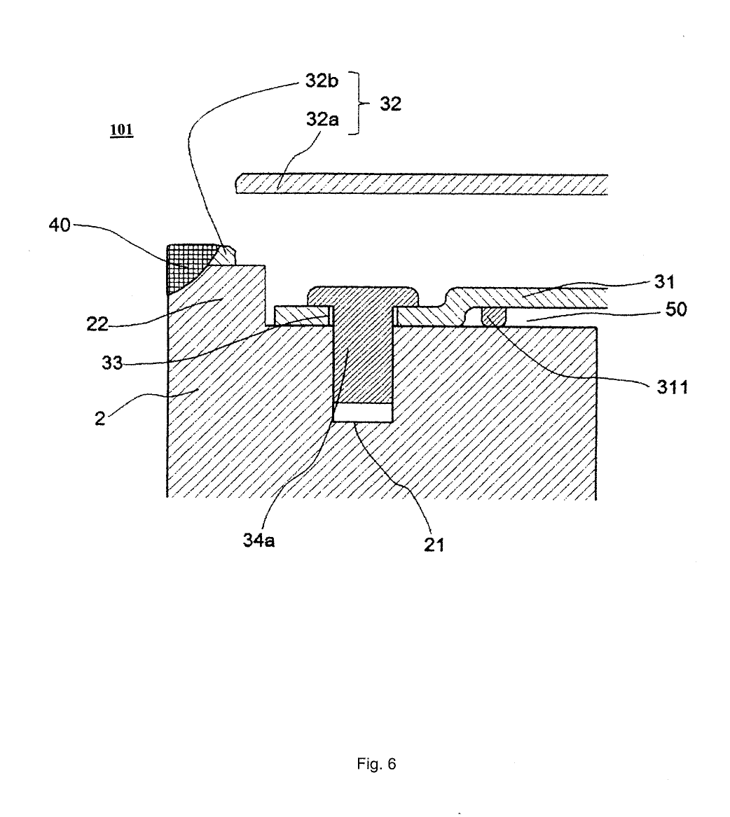

FIG. 6 is a cross section view along the line B-B of FIG. 1 of hard-disk drive 101 subsequent to the cutting second cover 32 and peeling of interior region 32a described above. As shown in FIGS. 5 and 6, exterior region 32b of second cover 32 remains coupled with casing base 2 by welded portion 40 and lies upon rib 22. Interior portion 32a of second cover 32 is now separated from exterior region 32b to expose the space (e.g., space 51 of FIG. 4) formerly enclosed between first cover 31 and second cover 32. In accordance with one or more embodiments, the cross-section area of second cover 32 is reduced at groove 321. As a result, stress is concentrated in the vicinity of groove 321 when interior region 32a is lifted up. Accordingly, a cleft is able to be easily created along groove 321 and second cover 32 can be more easily opened. In accordance with one or more embodiments, groove 321 defines the region in which shearing and breaking of second cover 32 is to occur to separate interior region 32a from exterior region 32b. Also, because groove 321 is disposed in such a way as to not overlie first cover 31, after interior region 32a has been separated, first cover 31 is accessibly so that screws 34a can be removed. Therefore, first cover 31 can be opened by unscrewing screws 34 without interference from a portion of second cover 32. The process described above for opening second cover 32 can be performed as a manual or automatic operation. Furthermore, it is not necessary for second cover 32 to provide mechanical strength or stiffness to hard-disk drive 101. As a result, second cover 32 is formed using a thin metal plate or foil in one or more embodiments. Furthermore, groove 321 facilitates opening second cover 32 which reduces the necessity for cutting or grinding operations to open hard-disk drive 101. As described above, in one embodiment, cutting or grinding of second cover 32 occurs in a small portion of its total area such as in region S shown in FIG. 5. Correspondingly, the generation of dust and chips from these operations is reduced and the likelihood of infiltration into the housing space 50 of hard-disk drive 101. As a result, contamination and damage to components of hard-disk drive 101 is reduced and the reliability of reworked components is improved. It is noted that in one or more embodiments groove 321 is disposed interior to rib 22, but still exterior to the outer edge of first cover 31. Additionally, while welded portion 40 is described as being laser welded, in other embodiments, second cover 32 can be coupled with casing base 2 using other methods such as soldering.

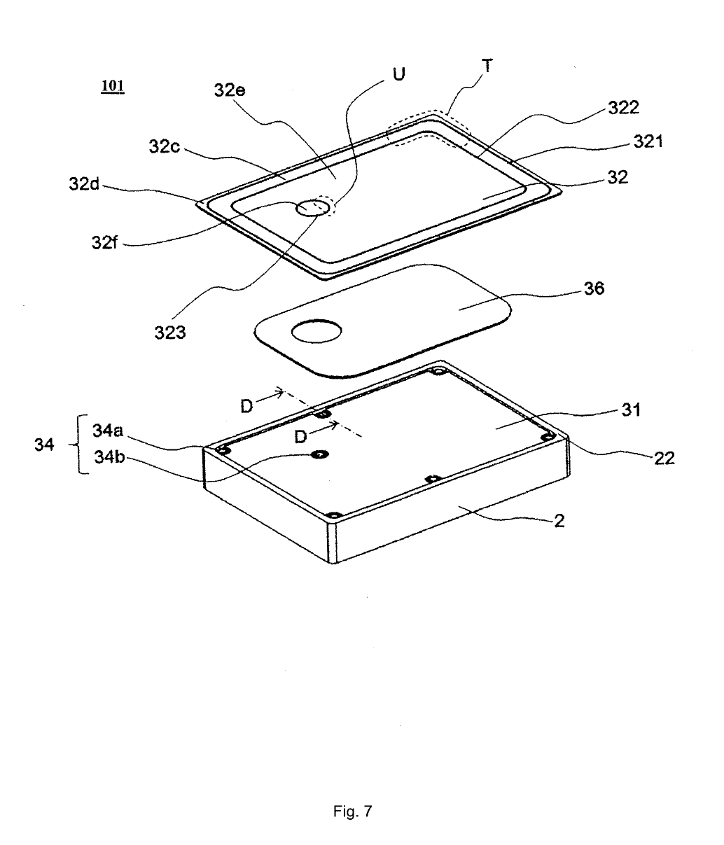

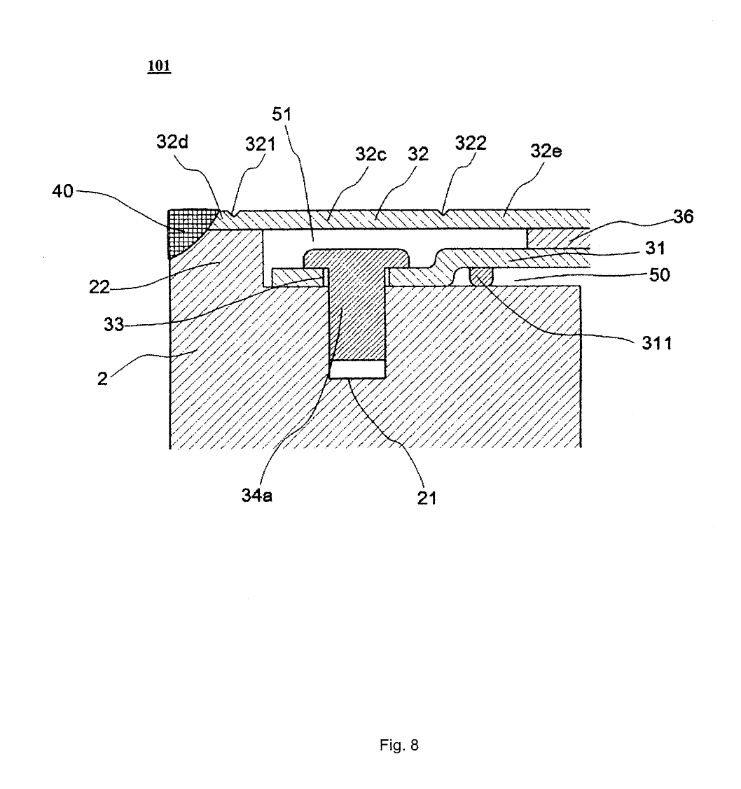

FIG. 7 is a perspective view of a hard-disk drive 101 in accordance with one embodiment. FIG. 8 is a cross section view of hard-disk drive 101 along the line D-D of FIG. 7. In the embodiment shown in FIGS. 7 and 8, an adhesive layer 36 is disposed between first cover 31 and second cover 32. In accordance with one embodiment, adhesive layer 36 provides additional strength to first cover 31 and second cover 32. In the embodiment shown in FIG. 7, adhesive layer 36 is disposed to avoid screws 34a and34b. Second cover 32 again comprises groove 321 which is disposed interior to welded portion 40 but does not overlie first cover 31 when second cover 32 is coupled with basing case 2. Second cover 32 further comprises a groove 322 which is interior of groove 321 but is disposed exterior to adhesive layer 36 when second cover 32 is coupled with casing base 2. It is again noted that groove 321 is disposed exterior to first cover 31. Grooves 321 and 322 delineate perimeters of an exterior region 32d, an intermediate region 32c, and an interior region 32e. Base screws 34a are positioned between groove 321 and groove 322. As shown in FIG. 7, second cover 32 further comprises a groove 323 which encloses the outer perimeter of a pivot region 32f which surrounds pivot screw 34b when second cover 32 is coupled with casing base 2. In the embodiment shown in FIGS. 7 and 8, while first cover 31 and second cover 32 are adhered by adhesive layer 36, the removal of adhesive layer 36 when the cover is opened may not be desired due to lowered workability of hard-disk drive 101. In an example embodiment of FIGS. 7 and 8, a cutting tool can be used to form a cutting line in groove 321 and 322 for the partial opening of second cover 32 such as at the region T shown by the broken line in FIG. 7. Thereafter, the intermediate region 32c of the second cover 32 is lifted up starting from region T, and intermediate region 32c is separated from second cover 32 by shearing and breaking along groove 321 and groove 322. In accordance with one or more embodiments, grooves 321 and 322 define the regions in which shearing and breaking of second cover 32 is to occur to separate exterior region 32d from intermediate region 32c, and intermediate region 32c from interior region 32e. Next, a cutting line is formed in groove 323 proximate to pivot screw 34b and is partially opened such as the region shown by the broken line U shown in FIG. 7. Thereafter, the pivot region 32f of second cover 32 is lifted up starting from the region U, and the pivot region 32f is separated from second cover 32 by shearing and breaking along groove 323. In accordance with one or more embodiments, groove 323 defines the region in which shearing and breaking of second cover 32 is to occur to separate interior region 32e from pivot region 32f. As a result, the intermediate region 32c and pivot region 32f of the second cover 32 are separated from second cover 32 and, because screws 34a and 34b are exposed, they can be unscrewed. After this, first cover 31, and the interior region 32e of second cover 32 and adhesive layer 36 can be removed as a single unit.

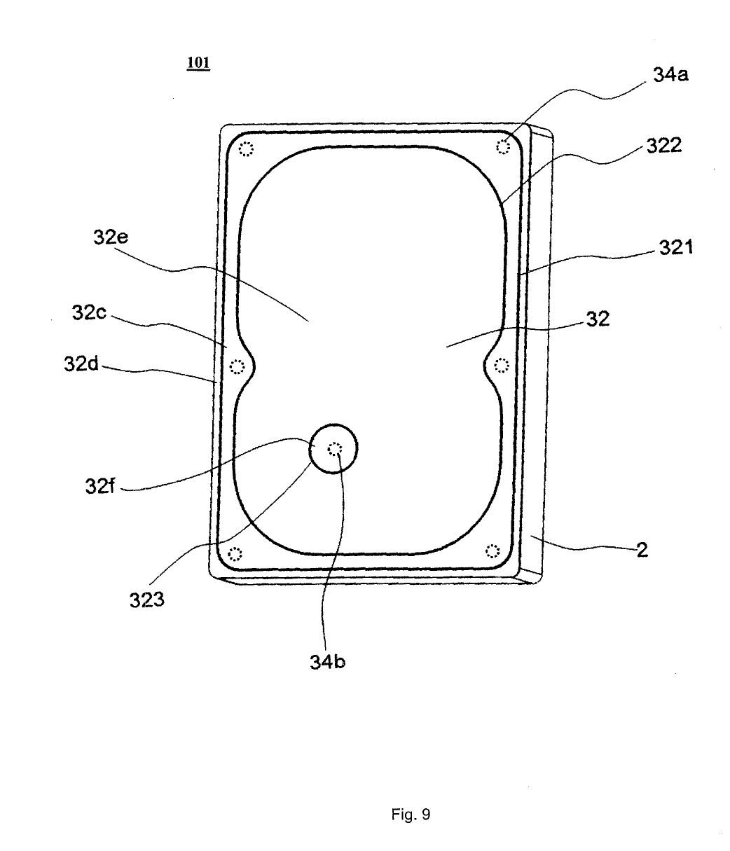

FIG. 9 shows a perspective view of hard-disk drive 101 having a modified contour of groove 322 in accordance with one or more embodiments. In FIG. 9, groove 322 is configured such that the width of intermediate region 32c is reduced, excluding the section surrounding base screws 34a. As a result of excluding the sections surrounding screws 34a, the area of adhesive layer 36 can be increased. In addition, the contour of groove 322 describes a smooth curved line of comparatively large radius. When, for example, groove 322 is formed linearly, or in a curve having a small radius of curvature, stress can concentrate on the corner portions of the groove when intermediate region 32c is removed which can renders fracture possible prior to complete removal of intermediate region 32c. In accordance with one or more embodiments, the shape of groove 321, groove 322, and groove 323 can be determined based upon the area and shape of adhesive layer 36 and the ease of opening intermediate region 32c and pivot region 32f.

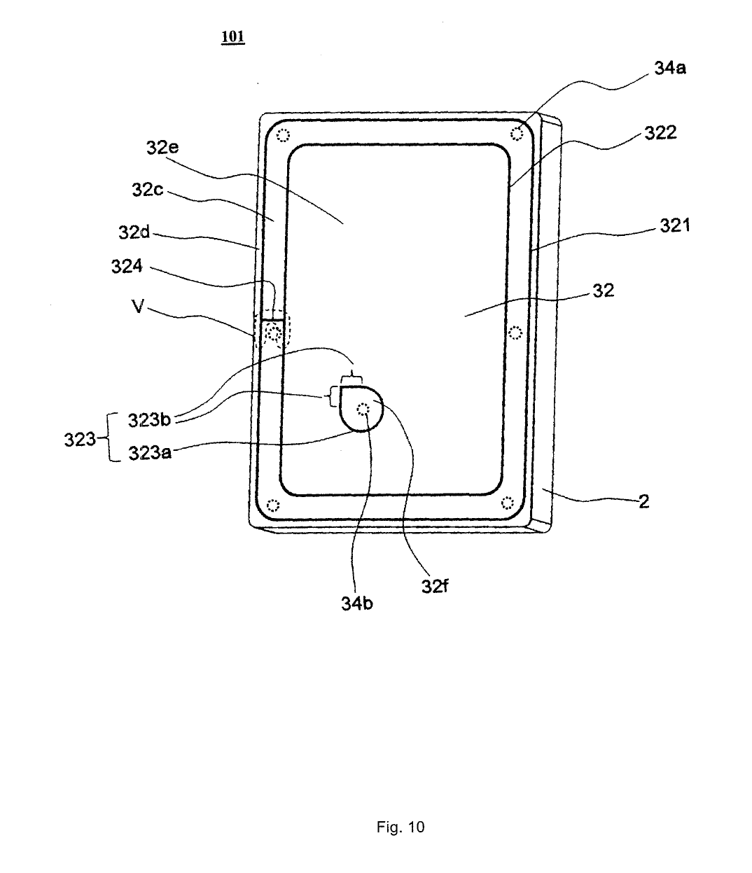

FIG. 10 is a perspective view of a hard-disk drive 101 in accordance with one or more embodiments. In FIG. 10, a groove 324 is provided between groove 321 and groove 322. In the embodiment of FIG. 10, one end of groove 324 is links with groove 321, while the other end of groove 324 links with groove 322. In accordance with one or more embodiments, a cutting tool is used to form a cutting line in groove 321, groove 322, and groove 324 for partially opening second cover 32 in the region V shown in FIG. 10. Then, intermediate region 32c of second cover 32 is lifted starting from region V by shearing and breaking along grooves 321 and 322 and intermediate region 32c is separated from second cover 32. Groove 323 is formed from a curved portion 323a and a linear portion 323b. When a cutting line is formed with a cutting tool, the linear portion 323b is cut. Then, pivot region 32f of second cover 32 is lifted and pivot region 32f is separated from second cover 32 by shearing and breaking along curved portion 323a of groove 323. In other words, formation of groove 324 and linear portion 323b of groove 323 can improve in separating intermediate region 32c and pivot region 32f of second cover 32.

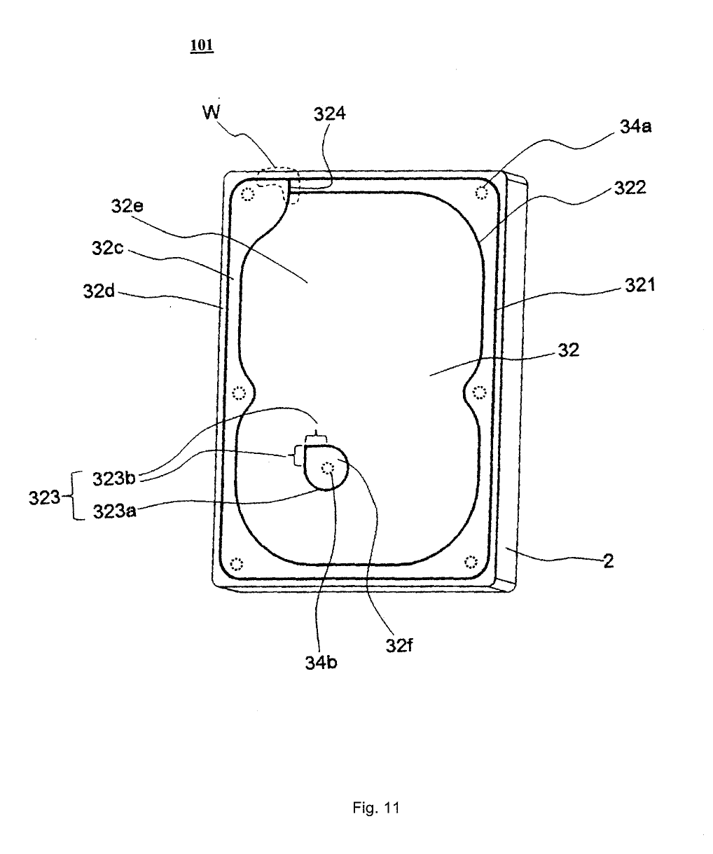

In addition, the shape of groove 321, groove 322, groove 323, and groove 324 is not limited to the shapes shown in FIG. 10. FIG. 11 is a perspective view of an example hard-disk drive in accordance with one or more embodiments. In the example of FIG. 11, groove 322 has a modified contour as described above with reference to FIG. 9. As with the embodiment described in FIG. 9, groove 322 is formed such that the width of intermediate region 32c is reduced excluding the section surrounding base screws 34a, and groove 322 is formed to describe a smooth curve of relatively large radius of curvature. Again, the provision of groove 324 can improve the workability associated with separating intermediate region 32c of second cover 32. As described above, a cutting tool is used to form a cutting line in groove 321, groove 322, and groove 324 in the region W shown by the broken line in FIG. 11 and intermediate region 32c is lifted starting from region W by shearing and breaking along groove 321 and groove 322.

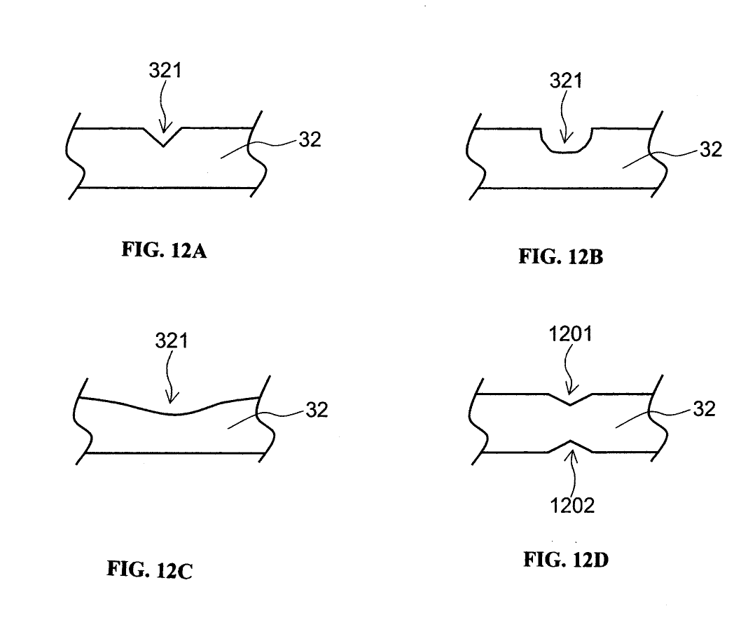

It is noted that there are a variety of cross-sectional shapes which can be implemented when forming groove 321, groove 322, groove 323, and groove 324 in accordance with one or more embodiments. FIGS. 12A, 12B, 12C, and 12D show example cross-sectional shapes of grooves in second cover 32 used in accordance with one or more embodiments. In the example shown in FIG. 12A, the cross-sectional shape of one or more grooves described above has a wedge-shaped cross section. In the embodiment shown in FIG. 12B, the cross-sectional shape of one or more grooves described above has a semi-circular shaped cross section. In the embodiment shown in FIG. 12C, the grooves described above are formed by reducing the thickness of second cover 32. In the embodiment shown in FIG. 12D, the grooves described above are formed using a first wedge-shaped cross-section 1201 on one side of second cover 32 and a second wedge-shaped cross-section 1202 on the opposite side of second cover 32. It is noted that various embodiments can use semi-circular, or other cross-sectional shapes, on both sides of second cover 32 as well. Additionally, groove 321, groove 322, groove 323, and groove 324 may be formed in the upper side and lower side of second cover 32 in the section in which a cutting line is initially formed using a cutting tool such as in regions S, T, U, V, and W as described above. In the remaining portions of groove 321, groove 322, and groove 323, the grooves are cut into the lower side of second cover 32. In addition, there are no limitations in how to form groove 321, groove 322, groove 323, and groove 324 in accordance with various embodiments. As an example, the above described grooves can be formed by press-molding of second cover 32, or by a mechanical processing operation such as by machining.

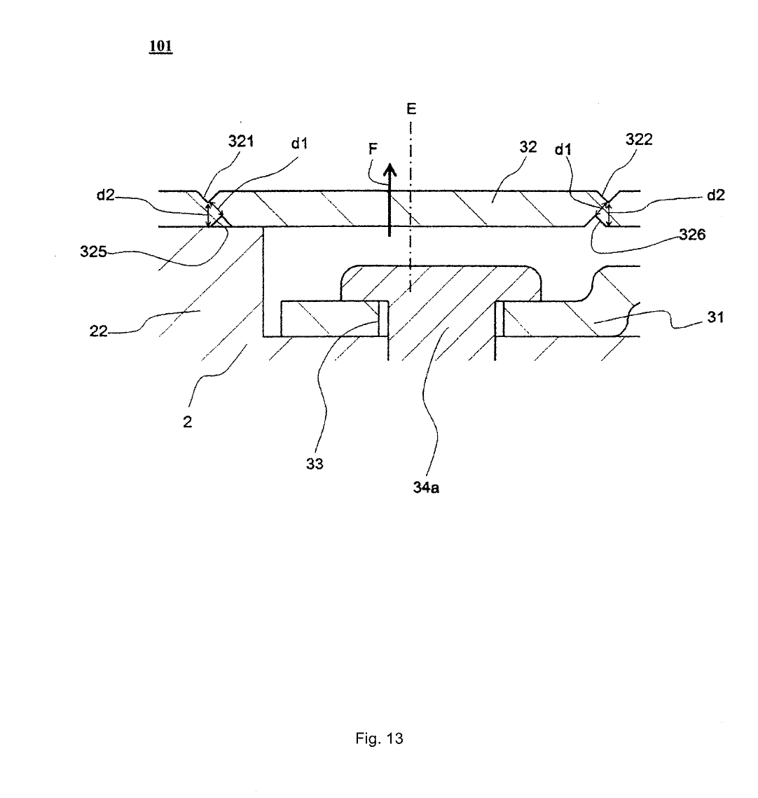

FIG. 13 shows an example of the arrangement of grooves in accordance with one or more embodiments. In the example of FIG. 13, groove 321 and groove 322 are provided in the upper side of second cover 32 and lower grooves 325 and 326 are provided in the lower side of second cover 32. In the embodiment shown in FIG. 13, groove 321, groove 322, and lower grooves 325 and 326 are symmetrically disposed with respect to a center plane E. However, the distance between groove 321 and groove 322 is larger than the distance between lower grooves 325 and 326. As shown in FIG. 13, the shortest distance between groove 321 and lower groove 325, as well as between groove 322 and lower groove 326 respectively, is the distance indicated by the distance d1. Additionally, the distance between groove 321 and the lower surface of second cover 32, as well as the distance between groove 322 and the lower surface of second cover 32, is represented by the distance d2. In accordance with one or more embodiments, grooves 321, 322, 325, and 326 are fabricated in such a way that both distances d1 are less than both distances d2. In addition, when intermediate region 32c is removed in the direction shown by F in FIG. 13, a fracture surface is formed in a direction from lower groove 325 toward groove 321, as well as from lower groove 326 toward groove 322. In other words, the fracture surfaces are formed to open in the direction of removal of intermediate region 32c and away from center plane E. As a result, the amount of dust generated by rubbing of the fracture surfaces is reduced.

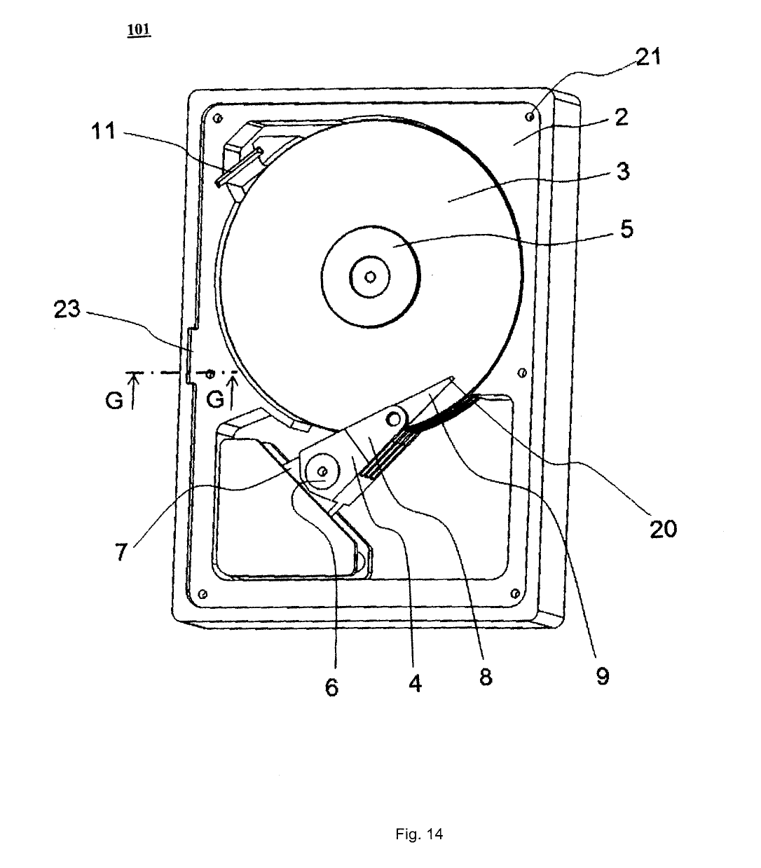

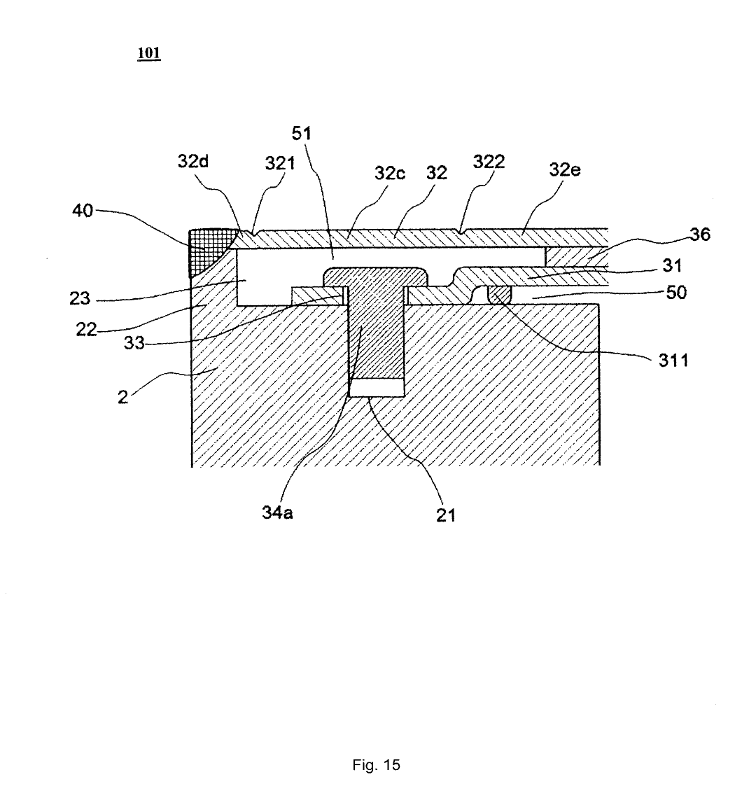

FIG. 14 is a perspective view of an example hard-disk drive 101 in accordance with one or more embodiments. In the view of FIG. 14, the interior of hard-disk drive 101 is visible due to the removal of first cover 31 and second cover 32, as well as adhesive layer 36 if utilized. FIG. 15 shows a cross-sectional view of the region shown by the line G-G in FIG. 14. As shown in FIGS. 14 and 15, a notch 23 is formed in a region of rib 22 underlying a region of second cover 32 where an initial cutting operation is to be performed. When a cutting operation is initiated to begin a cutting line, the cutting tool is initially placed at the portion of second cover 32 overlying notch 23. This gives additional space so that the tip or edge of a cutting tool used to cut second cover 32 does not come into contact with rib 22. As a result, less dust will be generated which reduces contamination and damage to components of hard-disk drive 101 and the reliability of reworked components is improved.

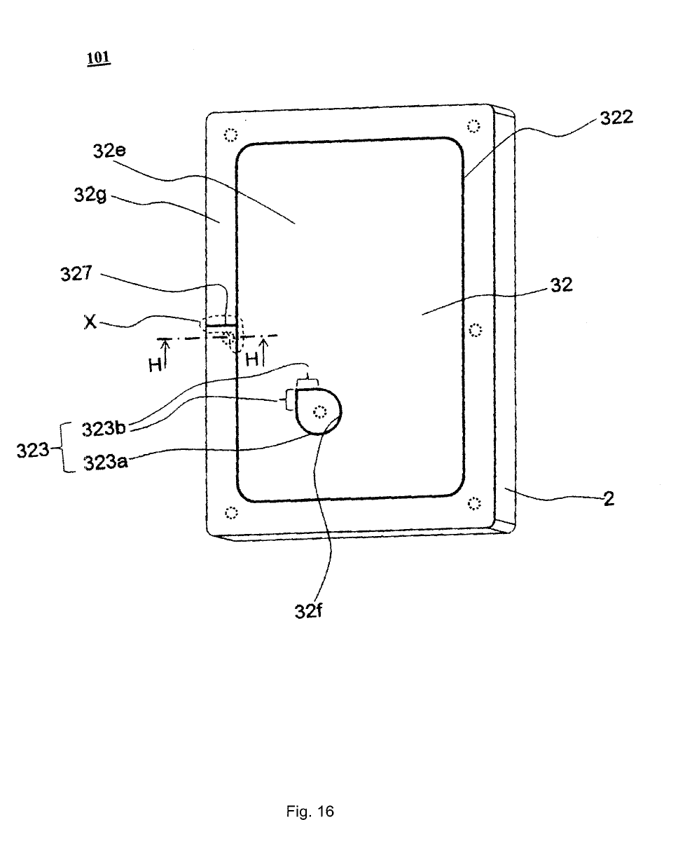

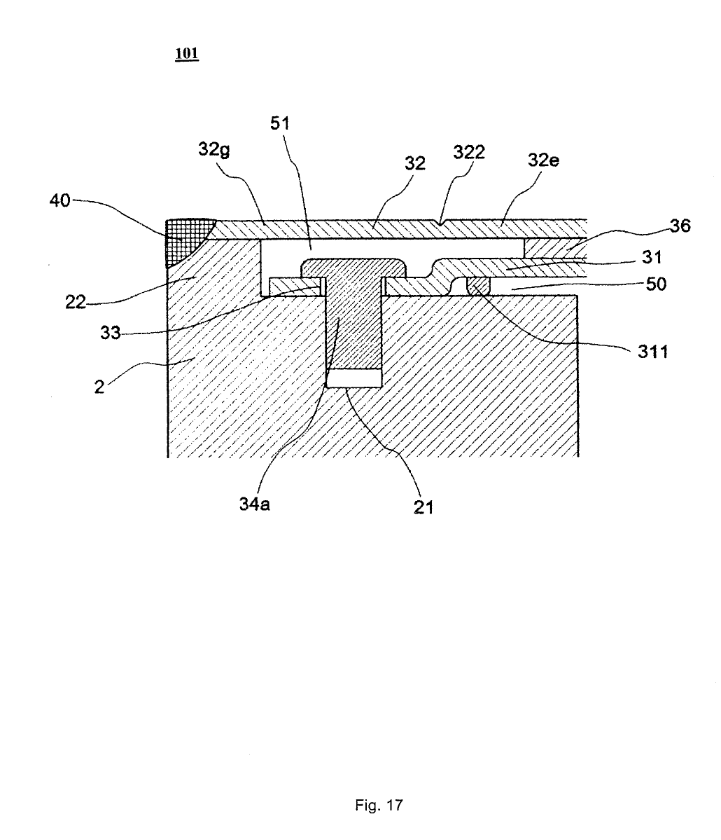

FIG. 16 is a perspective view of an example hard-disk drive 101 in accordance with one or more embodiments. FIG. 17 shows a cross-sectional view of the region indicated by the line H-H in FIG. 16. In the embodiment shown in FIGS. 16 and 17, groove 321 is not formed in second cover 32. Instead, groove 322, groove 323, and a groove 327 are formed. In the embodiment shown in FIGS. 16 and 17, one end of groove 327 links with groove 322 while the other end of groove 327 extends to welded portion 40. Groove 322 defines a perimeter which separates second cover 32 into an interior region 32e and an exterior region 32g. Groove 323 defines a perimeter which a pivot region 32f of second cover 32 from interior region 32e. A cutting tool can be used to form a cutting line in groove 322 and groove 327 which are partially opened in the region X shown by the broken line in FIG. 16. Then, exterior region 32g of second cover 32 is lifted up starting from region X, and the exterior region 32g is separated from second cover 32 by shearing and breaking along groove 322. Again, groove 322 defines the region in which shearing and breaking of second cover 32 is to occur to separate interior region 32e from exterior region 32g. At this time, a fracture surface is formed in the vicinity of groove 322 and welded portion 40. The fracture surface in the vicinity of welded portion 40 is formed in a boundary portion between welded portion 40 and second cover 32 and/or a boundary portion between welded portion 40 and rib 22. In one or more embodiments, the fracture is determined by the thickness and the material comprising second cover 32, the thickness and material of rib 22, and various other variables including, but not limited to, the welding strength of welded portion 40. The fracture typically occurs in the weak region between groove 322 and welded portion 40 of second cover 32 with respect to the lifting force exerted on exterior region 32g. After the exterior region 32g has been separated and removed from hard-disk drive 101, a cutting line can be formed in a part of groove 323 and pivot region 32f can be lifted and separated from second cover 32. Again, groove 323 defines the region in which shearing and breaking of second cover 32 is to occur to separate interior region 32e from pivot region 32f. Then, screws 34 can be removed and first cover 31, interior region 32e of second cover 32 and adhesive layer 36 are removed as one unit. In accordance with one or more embodiments, second cover 32 may exhibit greater strength in comparison with embodiments which use groove 321 as well. Furthermore, because of the absence of groove 321 in the vicinity of welded portion 40, the strength of second cover 32 with respect to the welding of welded portion 40, and also with respect to the thermal stress during the welding and the residual thermal stress following welding of welded portion 40 may be improved.

The foregoing descriptions of specific embodiments have been presented for purposes of illustration and description. They are not intended to be exhaustive or to be limiting to the precise forms disclosed, and many modifications and variations are possible in light of the above teaching. The embodiments described herein were chosen and described in order to best explain the principles and their practical application, to thereby enable others skilled in the art to best utilize various embodiments with various modifications as are suited to the particular use contemplated. It is intended that the scope be defined by the Claims appended hereto and their equivalents.

1. A removable cover assembly for a data storage device comprising:
a first cover coupled with a casing base of the data storage device via a plurality of screws; and
a second cover disposed upon a rib of said casing base and coupled therewith, said second cover configured with a groove which delineates a perimeter separating an interior region of said second cover from an exterior region of said second cover, wherein a space between said first cover and said casing base is filled with a low-density gas, and wherein said groove defines the region in said second cover in which separation of said interior region from said exterior region is to occur to expose said screws, wherein said exterior region of said second cover comprises a welding region at which said exterior region is welded to said rib, and wherein said welding region and an area comprising said groove are not the same.

2. The removable cover assembly of claim 1 wherein said groove defines a region in said second cover in which shearing and breaking of second cover is to occur to separate said interior region from exterior region.

3.-9. (canceled)

10. A removable cover assembly for a hard-disk drive comprising:
a first cover coupled with a casing base of the hard-disk drive via a plurality of screws; and
a second cover disposed upon a rib of said casing base and coupled therewith, said second cover configured with at least one groove which delineates a perimeter separating an interior region of said second cover from an exterior region of said second cover, wherein a space between said first cover and said casing base is filled with a low-density gas, and wherein said groove defines the region in said second cover in which shearing and breaking of second cover is to occur to separate said interior region from exterior region to expose said screws, wherein said exterior region of said second cover comprises a welding region at which said exterior region is welded to said rib, and wherein said welding region and an area comprising said groove are not the same.

11.-17. (canceled)

18. A hard-disk drive (HDD) configured with a removable cover assembly, said hard-disk drive comprising:
a magnetic disk;
a disk enclosure comprising a casing base;
a first cover coupled with said casing base of the hard-disk drive via a plurality of screws;
a second cover disposed upon a rib of said casing base and coupled therewith, said second cover configured with at least one groove which delineates a perimeter separating an interior region of said second cover from an exterior region of said second cover, wherein a space between said first cover and said casing base is filled with a low-density gas, and wherein said groove defines the region in said second cover in which shearing and breaking of second cover is to occur to separate said interior region from exterior region to expose said screws, wherein said exterior region of said second cover comprises a welding region at which said exterior region is welded to said rib, and wherein said welding region and an area comprising said groove are not the same;
a spindle motor affixed in said casing base, for rotating said magnetic disk;
an actuator arm; and
a magnetic head coupled with said actuator arm and configured to write data to, and read data from, said magnetic disk.

19.-25. (canceled)
